(19) United States
(12) Patent Application Publication
(10) Pub. No.: US 2025/0109930 A1
(43) Pub. Date: Apr. 3, 2025

(54) FOAM DEPTH INSPECTION GAUGE

(71) Applicant: LOUISIANA-PACIFIC CORPORATION, NASHVILLE, TN (US)

(72) Inventors: NEIL FREIDBERG, LEBANON, TN (US); PHILIP J VACCA, Jr., SAINT JOHN, IN (US); RYLIE BARLING, KANSAS CITY, MO (US)

(21) Appl. No.: 18/905,995

(22) Filed: Oct. 3, 2024

Related U.S. Application Data
(60) Provisional application No. 63/542,104, filed on Oct. 3, 2023.

(51) Int. Cl. G01B 3/28

(52) U.S. Cl. CPC G01B 3/28

(57) ABSTRACT

A gauge device for use in measuring and determining the depth and proper installation of a nail, screw, or similar fastener into a thick, relatively soft material, including but not limited to foam or a foam panel or board. The gauge has a linear casing or body with a needle extending from the base. The needle may be screwed into the base, or a friction/snug fit. The end of the needle is magnetized, or the needle is seated against an internal magnet in the casing, so the tip of the needle will attach to the head of the nail or screw when the needle is inserted into the fastener insertion point in the foam for testing. A gauge rod extends from the opposite end of the casing, indicating whether the fastener head is properly attached based on the depth or thickness of the foam.

This application claims priority to and benefit of U.S. Provisional App. No. 63/542,104, filed Oct. 3, 2023, which is incorporated herein in its entirety by specific reference for all purposes.

### FIELD OF INVENTION

This invention relates to a gauge to measure the depth and proper installation of a nail, screw, or similar fastener into a thick, relatively soft material, including but not limited to foam or a foam panel or board.

### BACKGROUND OF INVENTION

A structural panel with an outward-facing integrated foam layer is disclosed in U.S. Pub. App. No. 2024-0068232 (U.S. patent application Ser. No. 18/238,693), published Feb. 29, 2024, which is incorporated herein in its entirety by specific reference for al purposes. Insulating foam or foam board is adhered or attached to a manufactured wood structural panel (e.g., oriented strand board (OSB), plywood, or the like). The foam or foam board may be attached to an outer or exterior face of the panel, or other faces or parts thereof. When the foam layer is attached to an outer or exterior face of the panel, the fastener used (e.g., nail or screw) must penetrate the foam with minimal damage so the head of the fastener is seated flush with the corresponding face of the manufactured wood substrate to achieve the desired strength and proper attachment of the structural panel to a building framing or studs. Modified nailguns for installing such a panel is this way are disclosed in U.S. application Ser. No. 18/799,775 and U.S. application Ser. No. 18/799,754, filed Aug. 9, 2024, both of which are incorporated herein in their entireties by specific reference for all purposes.

After installation, the nail or screw is not visible from the surface of the foam board, and an installer or inspector would have to cut away the foam (or other opaque material) to visually inspect the seating of the nail or screw head. The foam that was cut away would compromise the integrity of the air barrier and/or water-resistive barrier intended for the structure, and would have to be reapplied in some fashion. Accordingly, what is needed is a device and method for determining that head of the fastener has penetrated the foam to such a depth as to be seated flush.

### SUMMARY OF INVENTION

In various exemplary embodiments, the present invention comprises a gauge for use in measuring and determining the depth and proper installation of a nail, screw, or similar fastener into a thick, relatively soft material, including but not limited to foam or a foam panel or board. The invention is of particular use with insulating foam or foam board adhered or attached to a manufactured wood structural panel (e.g., oriented strand board (OSB), plywood, or the like). The foam or foam board may be attached to an outer or exterior face of the panel, or other faces or parts thereof.

When installing such a combined panel, it is important to ensure that the head of the nail or screw, or similar fastener, is seated flush with the face of the manufactured wood substrate to achieve the desired strength and proper attachment of the structural panel to a building framing or studs. After installation, the nail or screw is not visible from the surface of the foam board, and an installer or inspector would have to cut away the foam (or other opaque material) to visually inspect the seating of the nail or screw head. The foam that was cut away would compromise the integrity of the air barrier and/or water-resistive barrier intended for the structure, and would have to be reapplied in some fashion. Both the installer and inspector can use the gauge described herein to make the determination of proper seating, and avoid having to cut away any portion of the foam or opaque material.

The gauge has a linear and/or cylindrical casing or body with a needle extending from the base. The needle may be screwed into the base, or a friction/snug fit. The end of the needle is magnetized, or the needle is seated against an internal magnet in the casing, so the tip of the needle will attach to the head of the nail or screw when testing. In one exemplary embodiment, the needle is held in the casing by the same magnet that magnetizes it. A gauge rod or indicator extends from the opposite end of the casing.

In several embodiments, the gauge may be used with any foam thickness. In one exemplary embodiment, the gauge has tick marks at 1/32″, 1/16″ and ⅛″ with a preset size of thickness (of the foam) at ½″, ¾″ and 1″, but can measure past those thicknesses. During use, the needle is inserted into the center of the insertion point in the exterior material (e.g., foam) until the user feels the tip of the needle make contact with the nail/screw head (which verifies a non-obstructed contact). The user then presses down on the casing (which causes the gauge to move out of the end of the casing) until it is flush with the outer surface of the exterior material, and the exposed end of the gauge rod displays the analog depth of the nail. A spring in the interior of the casing is used to keep the gauge from freely moving, and causes it to move back to its starting position after the user has ceased pressing down on the casing.

### BRIEF DESCRIPTION OF THE DRAWINGS

FIG. 1 shows a gauge device with a needle and gauge rod/indicator extending from the casing.

FIGS. 2 and 3 show an exploded view of the components of a gauge in accordance with embodiments of the present invention.

FIG. 4 shows a perspective view of a gauge casing.

FIG. 5 shows an example of a gauge with needle extended.

FIG. 6 shows a cutaway side view of storage mode.

FIG. 7 shows a cutaway end perspective view of storage mode.

FIG. 8 shows a cutaway side view of standby/pocket mode.

FIG. 9 shows a cutaway side view of a gauge device in use with a nail installed through a foam layer on a panel.

### BRIEF DESCRIPTION OF INVENTION

In various exemplary embodiments, the present invention comprises a gauge device 2 for use in measuring and determining the depth and proper installation of a nail, screw, or similar fastener 100 into a thick, relatively soft material, including but not limited to foam or a foam panel or board. The invention is of particular use with insulating foam or foam board 110 adhered or attached to a manufactured wood structural panel 120 (e.g., oriented strand board (OSB), plywood, or the like). The foam or foam board may be attached to an outer or exterior face of the panel, or other faces or parts thereof.

When installing such a combined panel, it is important to ensure that the head of the nail or screw, or similar fastener, is seated flush with the face of the manufactured wood substrate 120 to achieve the desired strength and proper attachment of the structural panel to a building framing or studs 130. After installation, the nail or screw is not visible from at or outside the surface of the foam board, and an installer or inspector would have to cut away the foam (or other opaque material) to visually inspect the seating of the nail or screw head. The foam that was cut away would compromise the integrity of the air barrier and/or water-resistive barrier intended for the structure, and would have to be reapplied in some fashion. Both the installer and inspector can use the gauge device 2 described herein to make the determination of proper seating, and avoid having to cut away any portion of the foam or opaque material.

As seen in the figures, in one exemplary embodiment the gauge device 2 has a cylindrical linear casing, body, or housing 10 with a depth needle 20 extending from the one end, sometimes referred to as the base. The base may comprise a cap 40 removably attached thereto.

The needle 20 may be screwed into the base, inserted into a hole 42 in the cap into the inside of the housing, and/or secured and held in place by a friction or snug fit. The distal end or tip 22 of the needle is magnetized, or the proximal end 24 of the needle is seated against an internal magnet 28 in the casing, so the tip of the needle will attach to the head of the nail or screw when testing. In one exemplary embodiment, the needle is held in the casing by the same magnet that magnetizes it. A gauge rod or indicator 30 extends from the opposite end of the casing, and the internal magnet may be affixed to or secured within the gauge rod.

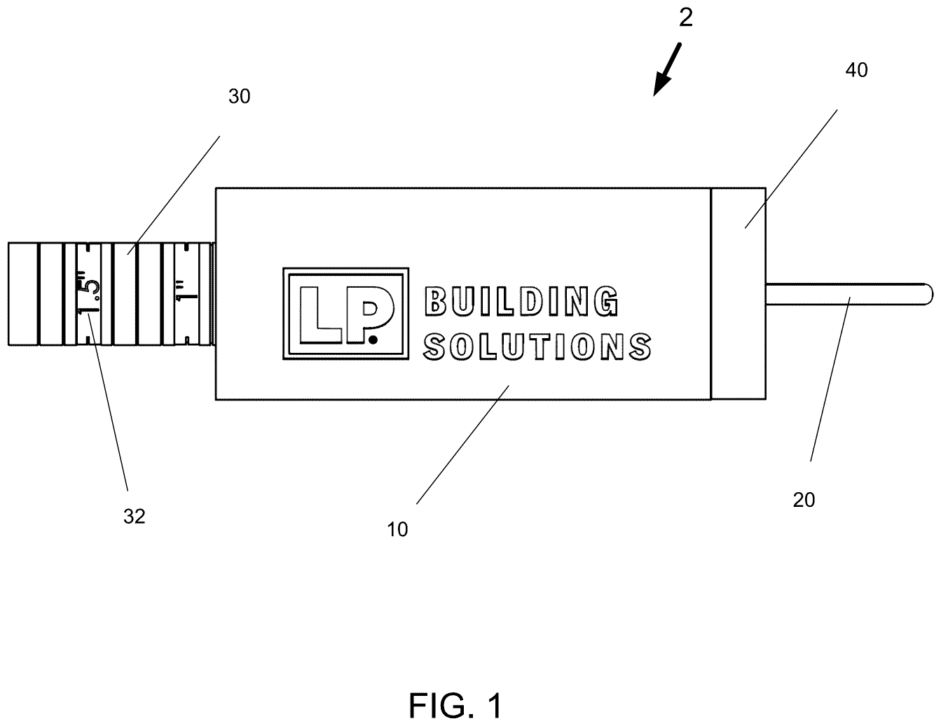

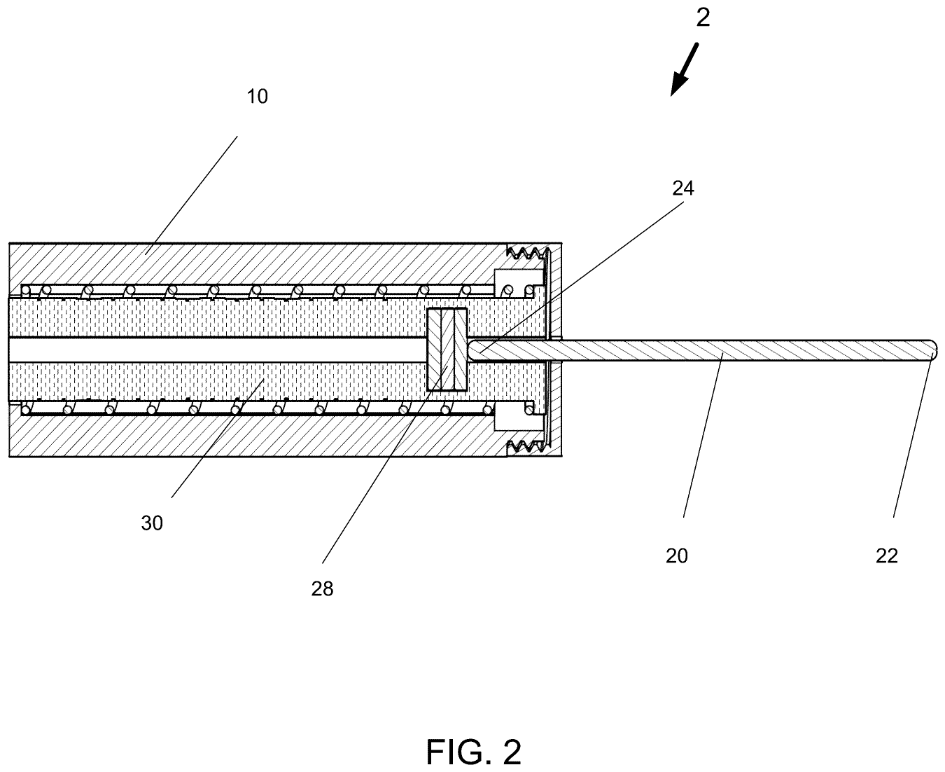

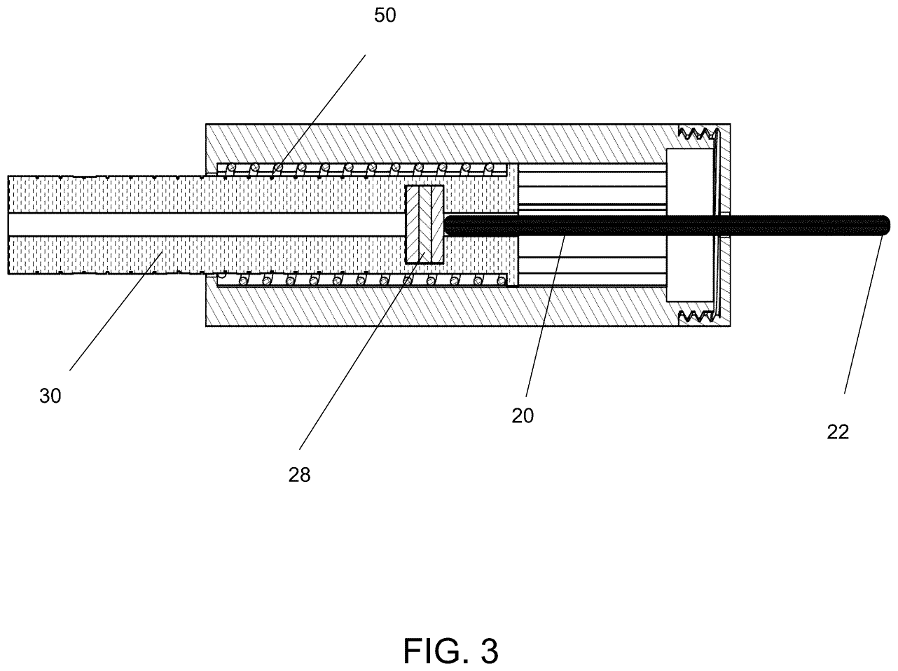

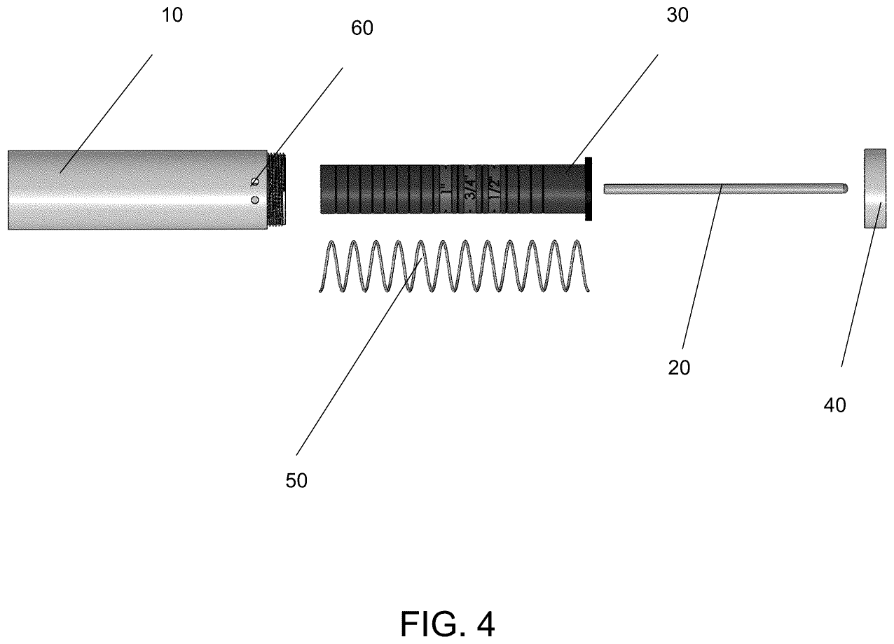

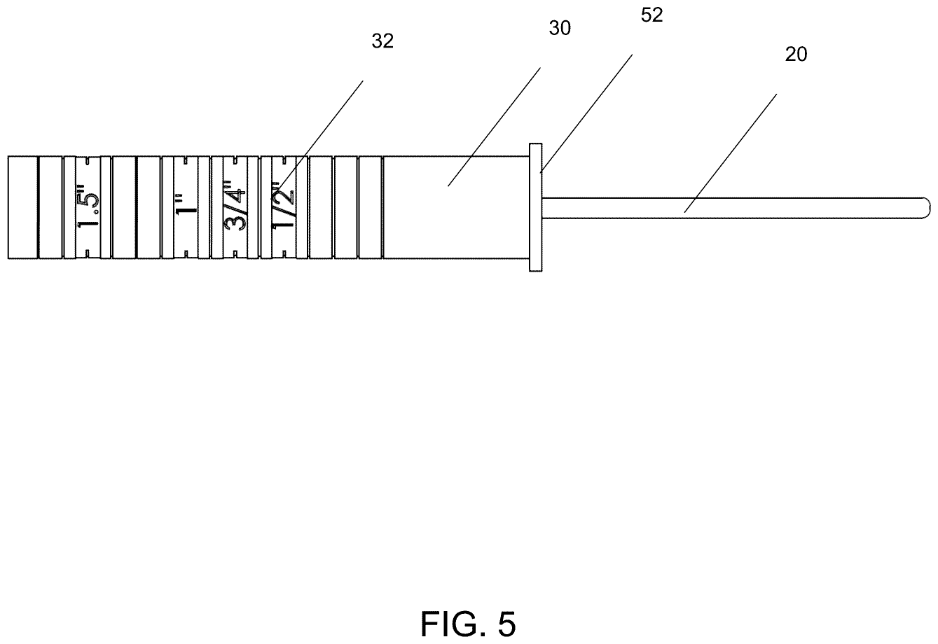

In several embodiments, the gauge device 2 may be used with any thickness of foam or similar material. In one exemplary embodiment, as seen in FIGS. 1 and 5, the gauge rod 30 has external tick marks 32 at 1/32″, 1/16″ and ⅛″, to correspond to a preset size of thickness of the foam at ½″, ¾″ and 1″, but can measure past those thicknesses.

During use, the distal end or tip 22 of the needle is inserted into the center of an insertion point for the fastener in the exterior material (e.g., foam) until the user feels the tip of the needle make contact with the nail/screw head. which verifies a non-obstructed contact. The user then presses down on the casing or housing 10, in a direction toward the nail/screw head, which causes the needle to push against the magnet/gauge rod, and thus the gauge rod 30 to slidingly move out of the distal end of the casing. The user stops pressing down when the distal end of the housing (which may be the top of the cap 40) becomes flush with the outer surface of the exterior material (foam). At this point, the exposed end of the gauge rod displays the analog depth of the nail, indicated by the marking 32 even with the proximal end of the housing. A spring 50 in the interior of the casing is used to keep the gauge rod from freely moving, and compresses as the gauge rod becomes more extended by a lip 52 or retainer at the distal end of the gauge rod contacting the end of the spring wound around the gauge rod. This compression causes the gauge rod to move back to its starting position after the user has removed any pressure (i.e., by removing the needle from contact with the fastener head).

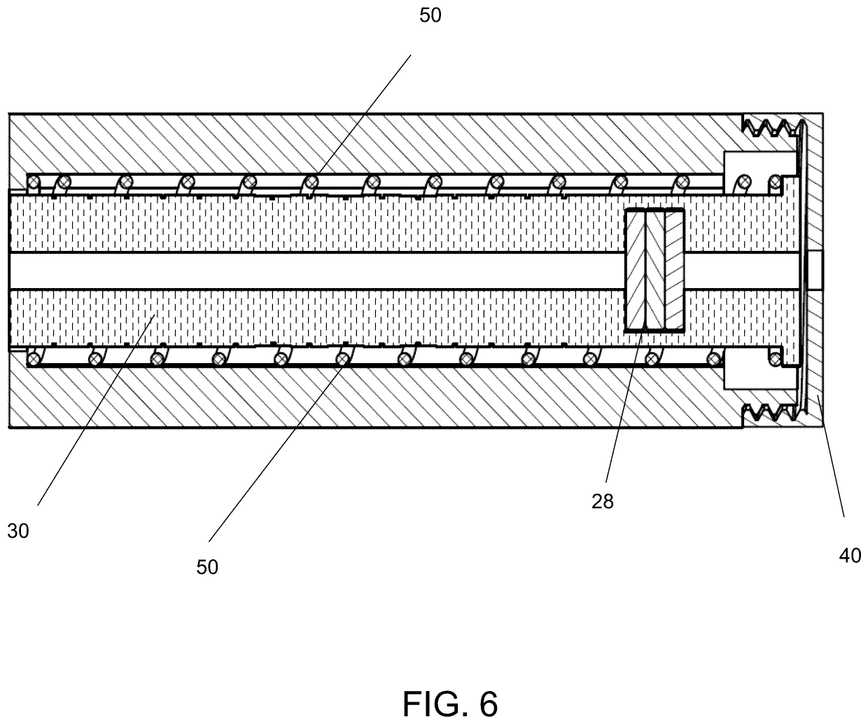

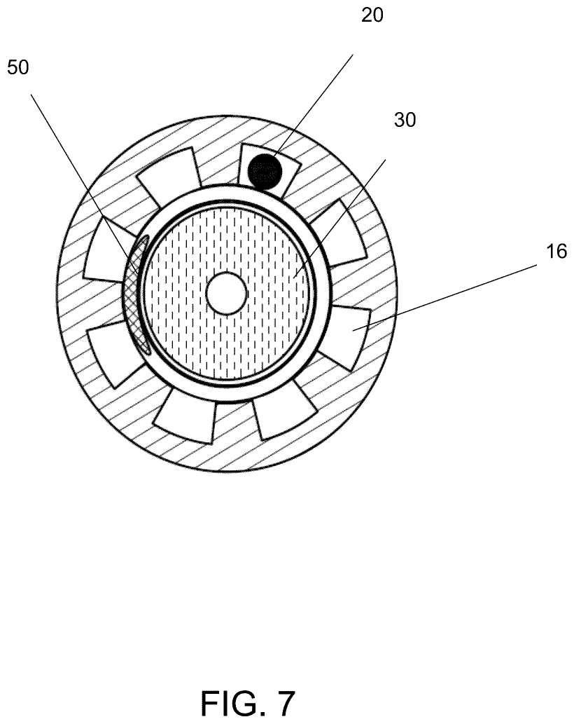

A slot or ring or holes 60 on the outside of the gauge casing or body allows for removable attachment of a rope, cord or ring that can be used to hang the gauge from a toolbelt or clothing item, or the user's wrist or neck. The top or cap 40 of the casing may be removably attached (e.g., by screwing, twist-locking, or friction fit), so that the needle, and possibly other components, can be placed in an interior compartment or space 16 in “storage mode” to prevent damage or loss when not in use, as seen in FIGS. 6 and 7.

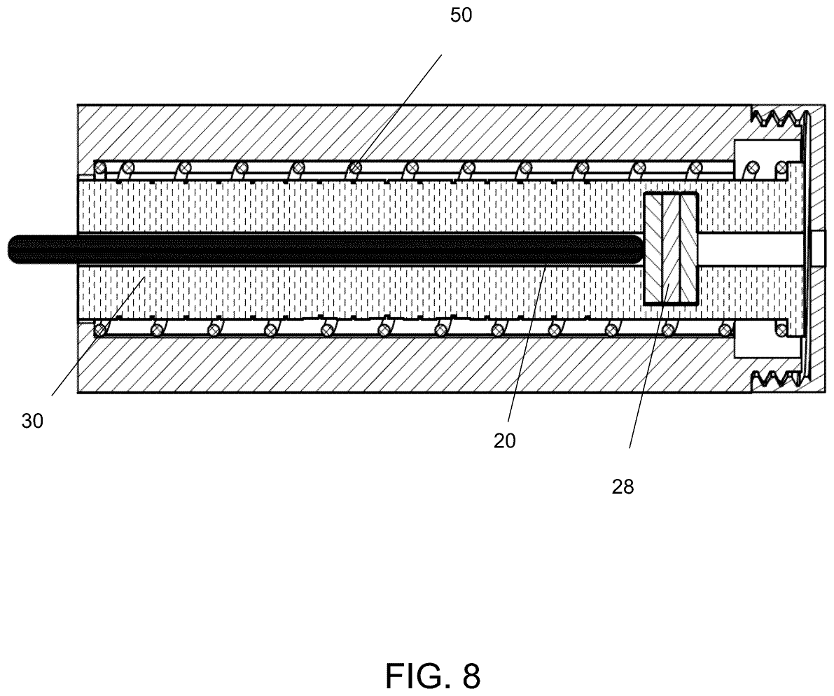

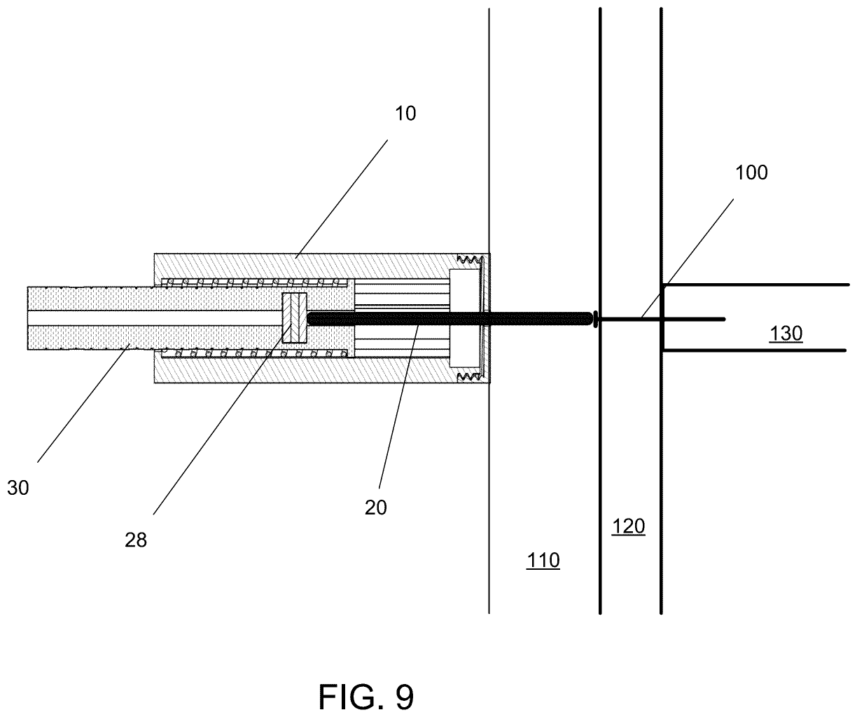

The present invention also has a “standby mode”, as seen in FIG. 8, for when the user has removed the needle from interior storage and expects to make a number of measurements over a period of time, and thus does not want to store the needle between measurements. The needle is inserted into a hole in the proximal end of the gauge rod 30 until it comes into contact with the magnet 28. In this mode, the majority of the needle 20 is located within the gauge rod and the interior of the housing, with only a small portion extending outward therefrom.

What is claimed is:

1. A device to determine proper installation of a fastener under a foam or soft material layer, comprising:
a gauge housing with a proximal end and distal end and wholly or partially hollow interior;
a gauge depth indicator with a proximal end and a distal end and a length, wherein the gauge depth indicator is slidingly engaged with the interior of the gauge housing, and configured to extend for a portion of its length out of the proximal end of the gauge housing;
a magnet disposed in the interior of the gauge depth indicator, with a hole extending from the magnet to the distal end of the gauge depth indicator;
a gauge needle with a proximal end and a distal end and a length, wherein the proximal end of the gauge needle is configured to engage the magnet and the length of the gauge needle extends outward through said hole;
wherein when the gauge housing is moved in a distal end direction to an extent that the distal end of the gauge needle cannot move any further in that direction, the gauge needle applies pressure to the magnet thereby causing movement of the gauge depth indicator in a proximate end direction, said movement ceasing when the distal end of the gauge housing contacts a surface of a a foam or soft material layer.

2. The device of claim 1, wherein the gauge depth indicator is cylindrical, and further comprising a spring disposed around the outside circumference of the gauge depth indicator.

3. The device of claim 1, wherein the spring undergoes compression when the gauge depth indicator is moving in a proximate end direction relative to the gauge housing.

4. The device of claim 1, further comprising a cap on either end of the gauge housing.

5. The device of claim 1, wherein the gauge needle is removable.

6. The device of claim 1, wherein the gauge housing comprises one or more storage space in the interior configured to accept and store the full length of the gauge needle.

7. The device of claim 1, further comprising a second hole extending from the magnet to the proximal end of the gauge depth indicator, said second hole configured to receive the gauge needle for at least part of the gauge needle's length.

8. The device of claim 1, the gauge depth indicator comprising one or more numeric indicators on its exterior, such that the numeric indicator aligned with the proximal end of the gauge housing when the distal end of the gauge housing contacts a surface indicates whether the distance the distal end of the gauge needle extends from the distal end of the gauge housing is comparable to a thickness of the foam or soft material layer.

9. The device of claim 1, wherein the gauge needle comprises metal at least at both ends, wherein the metal at the distal end of the rod comprises a magnet.

10. The device of claim 1, wherein the gauge needle comprises metal for its length, such that contact with the magnet with the proximal end magnetizes the distal end of the gauge needle.

11. A method of using the device of claim 1, comprising:
inserting the proximal end of the gauge needle into the hole until the gauge needle contacts the magnet;
applying pressure to the gauge housing to insert the distal end of the gauge needle into a fastener insertion point in a foam or soft material layer in which a fastener with a head has been installed, until the distal end of the gauge needle establishes magnetic contact with the head of the fastener; and
continuing applying pressure to the gauge housing to cause the proximal end of the gauge indicator to slide from the proximal end of the gauge housing, until the distal end of the gauge housing contacts a top surface of the foam or soft material layer.

12. The method of claim 11, further comprising the step of reading an indicator on the exterior of the gauge indicator.

13. The method of claim 12, further comprising the step of determining whether the head of the fastener is in contact with or flush with a top surface of a substrate layer underlying the foam or soft material layer
